(19) United States
(12) Patent Application Publication
(10) Pub. No.: US 2008/0042116 A1
(43) Pub. Date: Feb. 21, 2008

(54) Fence Post Connector

(75) Inventor: James A. Buckley, Whitefish Bay, WI (US)

Correspondence Address: BOYLE FREDRICKSON S.C., 840 North Plankinton Avenue, MILWAUKEE, WI, 53203, US

(73) Assignee: CHIPLESS METALS L.L.C., Milwaukee, WI (US)

(21) Appl. No.: 11/840,009

(22) Filed: Aug. 16, 2007

Related U.S. Application Data
(60) Provisional application No. 60/822,584, filed on Aug. 16, 2006.

(51) Int. Cl. E04H 17/24; E02D 5/74; F16D 1/00; E04H 17/14

(52) U.S. Cl. 256/65.01; 256/59; 403/362; 405/232

(57) ABSTRACT

A connector for a steel fence or the like is provided. The connector is formed from a single, cast metallic piece yet can mount one or multiple adjacent rail sections on a post using only a single mount or piece of hardware attaching the connector to the post. It has a vertical throughbore for receiving the post and a horizontal throughbore that intersects with the vertical throughbore at approximately its mid-point. Each end of the horizontal throughbore forms a receptacle for receiving an end of an associated rail section. A grommet is mounted in each receptacle for centering the associated rail section end in the receptacle, locking the rail section from rotation. The grommet also accommodates limited pivoting of the rail section relative to the connector in both the horizontal and vertical planes, hence, accommodating both inclination and directional changes in the fence.

### CROSS-REFERENCE TO RELATED APPLICATIONS

This application claims priority under 35 U.S.C. §119 from U.S. Provisional Patent Application Ser. No. 60/822,584, filed on Aug. 16, 2006 and entitled “Fence Post Connector,” which is herein expressly incorporated by reference in its entirety.

### BACKGROUND OF THE INVENTION

1. Field of the Invention

The invention relates to fence post connectors and fences buildable therewith. More particularly, the invention relates to a cast metal fence post connector for a so-called steel fence and to a steel fence having those fence post connectors. In addition, the invention relates to methods of making the connector and the fence.

2. Discussion of the Related Art

Livestock fences, particularly horse fences, are typically formed from horizontally extending, tubular steel rails mounted on vertical tubular posts anchored to the ground. This “steel fence” is widely considered to be superior to split rail and other types of fences because it is rigid and extremely durable. However, the individual rail sections of the typical steel fence must be welded to the vertical fence posts. This welding requirement adds considerable time and labor to building the fence because a portable welder must be employed to weld the opposite ends of each and every rail to the posts on which it is supported. The welds must then be ground to a smooth finish and painted. The welds are subject to rust and peeling, requiring periodic maintenance for the lifetime of the fence.

More recently, a non-welded connector for steel fences has been introduced. This connector, known as the “440 Fence” connector, is manufactured by the 440 Fence Company of Aubrey, Tex. It is also the subject matter of U.S. Design Pat. No. 495,434. The 440 Fence utilizes two stacked connectors at each joint. Each connector is generally L-shaped, having a vertical section for slipping over the fence post and a generally horizontal section that receives the end of a rail section. The horizontal section is hinged to the vertical section so as to permit limited pivoting of the horizontal section relative to the vertical section in order to accommodate inclines of the fence. In use at a “mid-joint” of the fence (i.e. a location along the fence in which the rails extend in opposite directions from the fence post), two connectors are stacked in a mirror image fashion such that the vertical sections of the two connectors abut one another and the horizontal sections extend outwardly from the vertical section in opposite directions in alignment with one another. With these connectors, a steel fence can be built without welding—dramatically reducing labor when compared to traditional steel fence construction. Post-assembly maintenance is also dramatically reduced.

However, the 440 Fence connector still suffers from drawbacks. For instance, its multi-piece hinged construction makes it relatively expensive to produce. In addition, two connectors and a total of six setscrews are required at each mid-joint in the fence. It also does not automatically center the pipe of the rails in the connector. In addition, although it can accommodate significant changes in elevation, it can also permit round or odd shaped corrals due to its ability to be pivoted about the post.

The need therefore has arisen to provide a simplified connector for fences including steel fences.

The need has also arisen to provide a connector that can be installed quickly and with minimal effort.

The need has also arisen to provide a connector that lacks a hinge yet can accommodate adjacent rail sections that are inclined and/or extend in different directions relative to one another.

### SUMMARY OF THE INVENTION

In accordance with various aspects of the invention, at least some of the above-identified needs are met by providing, e.g., a cast metal mid-joint connector for a steel fence or the like. The connector is formed from, preferably, a single unitary piece, yet can mount two adjacent rail sections on a post using only a single mount attaching the connector to the post. It preferably has a vertical throughbore for receiving the post and a horizontal throughbore that intersects with the vertical throughbore at approximately its mid-point. Each end of the horizontal throughbore forms a receptacle or socket for receiving an end of an associated rail section. Preferably, the socket is oversized as compared to the rail section. In this configuration, the clearance or “rocking tolerance” provided by the oversized socket enables the connector device to movably house the end of an elongate rail. As one example, the rail section can be multiaxially movable with respect to the socket and/or the remainder of the connector device. The socket can be configured to provide a rocking tolerance of at least about 12 degrees, 15 degrees, 20 degrees, or otherwise as desired, of angular deviation from a neutral position, where the rail extends directly axially from the socket.

In some implementations, the connector includes a threaded internal boss extending into the vertical throughbore and adapted and configured to receive a setscrew assembly. The setscrew assembly includes a setscrew which can have, e.g., a hardened steel insert, and/or a resilient member extending from an end surface thereof for temporarily fixing the connector to and interfacing with the post.

An isolating member such as, e.g., a grommet or another elastomeric, polymeric, or otherwise resilient member, is mounted in each receptacle for centering the associated rail section end in the receptacle, locking the rail section from rotation. The grommet also accommodates limiting pivoting or actuation of the rail section relative to the connector in both the horizontal and vertical planes, hence, accommodating both inclination and directional changes in the fence. The grommet can be generally annular or cylindrical with opposing, generally circular side surfaces. The side surfaces can have differently sized openings, each of which opens into a common bore. Preferably, in the complete assemblage, the relatively larger opening is proximate the rail section whilst the relatively smaller opening is distal the rail section. This configuration facilitates the insertion of the rail section through the larger opening and corresponding resists its withdrawal from the smaller opening, whereby the rail section is relatively easy to place into the connector yet relatively more difficult to remove therefrom.

In some embodiments, the connector and the rail segment are made of dissimilar materials, whereby the grommet electrically isolates the connector and rail from each other. This configuration provides, e.g., a dielectric union between the connector and the rail segment and correspondingly mitigates the likelihood of galvanic-type corrosion event, based on two interfacing dissimilar metals.

In other implementations, the end of the rail segment includes a projection extending radially therefrom. Such projection can be an integral part of the rail segment or it can be provided by way of, e.g., a cap or other structure connected to the end of the rail. The projection can be a discrete element or can extend about a portion or the entirety of an outer circumferential surface of the end of the rail segment. In any event, the projection provides a mechanical abutment or interference between it and the grommet which prevents the non-desired withdrawal of the rail segment from the connector.

Other connectors, having the same post mount but specialized receptacle configurations, may be provided for corner or end posts. Yet other connectors can allow post penetration at an angle for extreme slopes.

Connectors configured as discussed above and elsewhere herein are also provided, methods of making connectors configured as discussed above are also provided, and methods of building fences using various connectors configured as discussed herein are also provided.

### BRIEF DESCRIPTION OF THE DRAWINGS

Preferred exemplary embodiments of the invention are illustrated in the accompanying drawings, in which like reference numerals represent like parts throughout, and in which:

FIG. 1 is perspective view of a fence post connector constructed in accordance with a preferred embodiment of the invention, viewed from in front of, above, and from the left side of the connector;

FIG. 2 is a front elevation view thereof;

FIG. 3 is a rear elevation view thereof;

FIG. 4 is a top plan view thereof;

FIG. 5 is a bottom plan view thereof;

FIG. 6 is a left-end elevation view thereof, with the right end being a mirror image of the left end;

FIG. 7 is an exploded perspective view of the connector;

FIG. 8 is a sectional plan view showing the connector in use; and

FIG. 9 is a side elevation view of a section of fence incorporating the connectors of FIGS. 1-8.

### DETAILED DESCRIPTION OF THE PREFERRED EMBODIMENTS

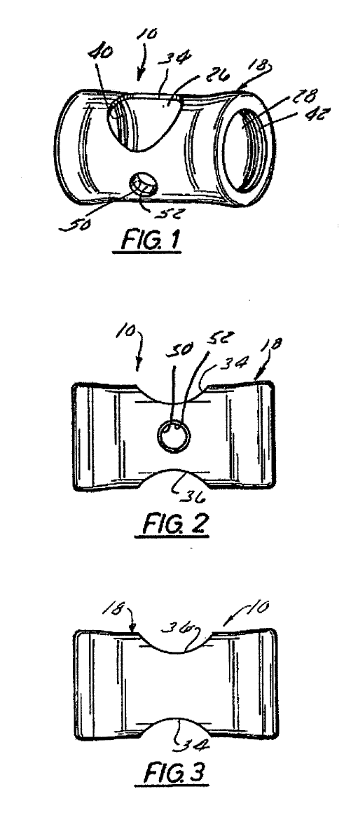

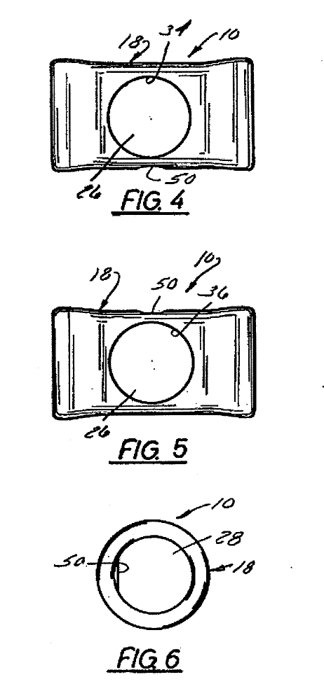

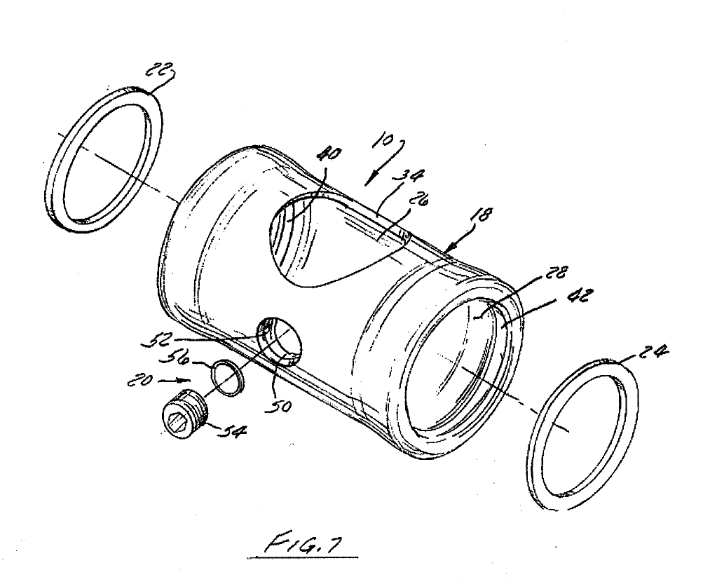

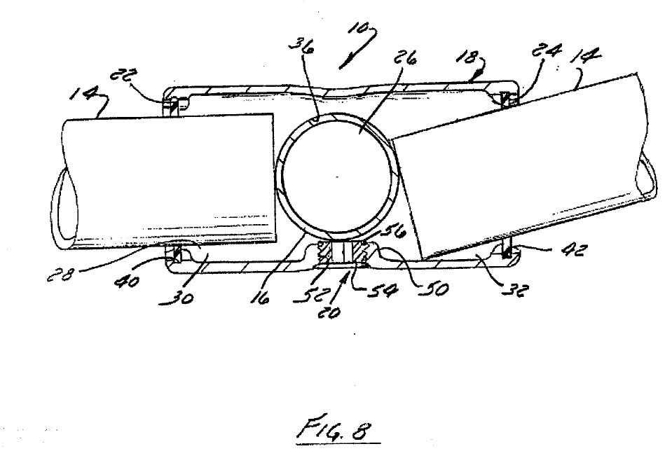

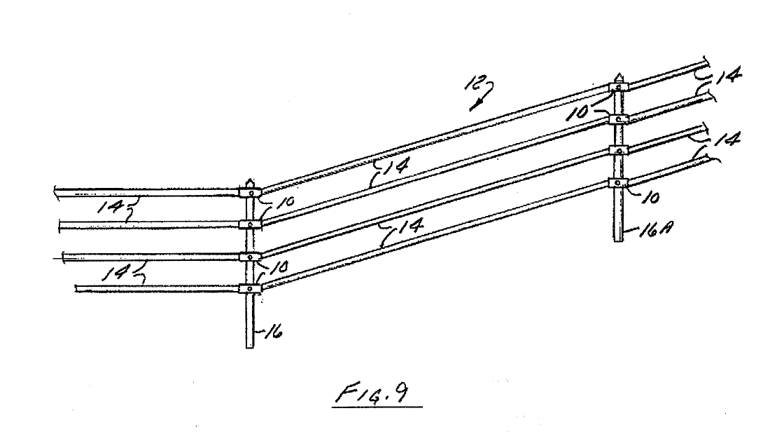

Referring to FIGS. 1-7, a fence post connector 10 constructed in accordance with a preferred embodiment of the invention is illustrated. As seen in FIGS. 8 and 9, the connector 10 is configured for use as a mid-joint connector for a steel fence 12 formed from horizontal rails sections 14 and vertical posts 16 formed from steel tubes. The posts 16 and rail sections 14 are typically of a common diameter, most typically 2.875″ or 2.375″. The connector 10 comprises a body 18, a setscrew assembly 20 for affixing the body 18 to a fence post 16, and a pair of grommets 22, 24.

Referring to FIGS. 1-6, the body 18 preferably is formed from cast aluminum because aluminum cannot rust. However, the body 18 could be formed from other materials such as cast iron, and could be formed from other processes as well, such as by machining a rolled tube. If it is formed from a cast material, the body 18 is even more preferably formed from casting a semi-solid shot of a thixotropic material such as thixotropic aluminum about a core of a material, such as zinc, that has a lower melting point than the solid to semi-solid transition temperatures of the thixotropic alloy. The core is later melted away to form internal features of the body 18 such as threads, undercuts, etc. Hence, the entire body 18 can be formed without any post-casting machining. This casting process is described, for example, in U.S. Pat. Nos. 6,564,856 and 6,427,755; and U.S. application Ser. No. 10/438,954, filed May 15, 2003, all of which are assigned to the assignee of this application, and the disclosures of all of which are hereby incorporated by reference in their entirety.

Still referring to FIGS. 1-6, the body 18, which weighs about 1.0 lb (as opposed to 3.7 lbs. if it were formed in cast gray iron), is essentially tubular in shape, having a length of about 7″ and an outer diameter of about 4″. The body 18 has a vertical throughbore 26 for receiving the fence post 16 and a horizontal throughbore 28 that intersects with vertical throughbore 26 at approximately its mid point. Each end of the horizontal throughbore 28 forms a socket 30, 32 for receiving an end of an associated rail section 14. The vertical throughbore 26 is formed from aligned radial openings 34, 36 at approximately the longitudinal mid-point of the connector 10. The vertical throughbore 26 should be slightly larger in diameter than the fence post 16 over which it is adapted to slide. In the illustrated embodiment in which the connector 10 is configured for use with a fence post 16 and rail sections 14 each having an outside diameter of 2.875″, the vertical throughbore 26 has a diameter of 2.92″. The horizontal throughbore 28 should be significantly larger in diameter than the diameter of the ends of the rail sections 14 so as to allow substantial rocking of the ends of the rail sections 14 relative to the post 16. About 12 degrees to 20 degrees of rocking tolerance is preferred when the rail sections 14 are fully inserted into the corresponding sockets 30, 32 in an abutting relationship with the fence post 16 as seen in FIG. 8, with a rocking tolerance of 15 degrees being especially preferred. This rocking is accommodated by oversizing the horizontal throughbore 28 and by the flexible grommets 22, 24, described below. In the illustrated example in which the connector 10 is configured for use with rail sections 14 having a diameter of 2.875″, the horizontal throughbore 28 has an inner diameter of about 3.5″, reduced to a minimum of 3.0″ at the grommets 22, 24. The grommets 22, 24 are mounted in grooves 40, 42 formed in the extreme outer ends of the horizontal throughbore 28. The grooves 40, 42 may, if desired, be circumferentially segmented to form a number of fingers (not shown) for gripping the grommets 22, 24. Finally, a threaded internal boss 50 is formed at the axial mid-point of the connector 10, circumferentially spaced about 90 degrees from the vertical throughbore 26, for receiving the setscrew assembly 20. The threads 52, like the grooves 40, 42 and all undercuts, are preferably formed during the casting and subsequent core melt-out processes, negating the need for any post casting machining.

Each grommet 22, 24 functions to hold the end of the corresponding rail section 14 in place in the corresponding socket 30, 32 and to center the rail section 14 end in the socket 30, 32 while accommodating the desired side to side and vertical rocking of the rails 14 relative to the connector 10. Each grommet 22, 24 has an outside diameter of 3.67″ and an inside diameter of 2.85″. The grommets 22, 24 can be inserted into the grooves 40, 42 after the body 18 is inserted. The grommets 22, 24 are preferably formed from a rubber material having a hardness of 60 Durometer Shore A. An EPDM elastomer is preferred because of its relatively high resistance to ozone and UV, as well as its toughness and low cost.

As noted above, steel fences 12 often are constructed from rail sections 14 and fence posts 16 having a diameter of 2.375″. In this case, the entire connector 10 can be downsized to meet the requirements of the smaller rails and posts. For instance, the vertical throughbore 26 has a diameter of 2.42″. The horizontal throughbore 28 has a diameter of about 3.0″, reduced to a minimum of 2.5″ at the grommets 22, 24.

The setscrew assembly 20 could be formed from or replaced by any number of devices capable of securing the connector 10 to the fence post 16. In the illustrated embodiment, a single setscrew assembly 20 is employed. As best seen in FIGS. 7 and 8, the setscrew assembly 20 preferably comprises a zinc setscrew 54 fitted with a hardened steel insert 56 for gripping the fence post 16.

Referring to FIGS. 8 and 9, to use the mid-joint connector 10, the installer simply mounts the connectors 10 at the appropriate heights on the first fence post 16 using the setscrew assemblies 20, resulting in four spaced connectors on the post 16, in the case of the four rail fence illustrated in FIG. 9. The operator then inserts a rail section 14 into the socket 32 of the lowermost connector 10, slides a connector 10 over the second post 16A, and slides that connector 10 down to a position in which the rail section 14 is tilted up at least 5 degrees, which provides sufficient spacing between the end of the rail section 14 and the post 16A to provide clearance for the end of the rail section 16A and the opening of the socket 30. As the installer continues to lower the connector 10, the end of the rail section 14 become fully inserted into the socket 30 by the time the rail is horizontal, whereupon the installer fastens the connector 10 to the post 16A using the setscrew assembly 20. The installer then repeats the procedures for the second and subsequent connectors and rail sections 14 on the post 16A. The grommets 22, 24 hold the rail sections 14 in place without damaging the finish on the rail sections 14. They also center the rail sections 14 in the connector 10. Hence, two rail sections 14 are mounted on a post 16 using a single connector 10 and a single setscrew 54. Comparing post 16 to post 16A in FIG. 9, significant rail inclination and change in direction are accommodated by the grommets 22, 24 and the oversizing of the sockets 30, 32. Rail sections 14 can be mounted on corner posts and end posts using 440 Fence connectors or specialized connectors illustrated in the materials collectively attached as Appendix A, the subject matter of which is hereby incorporated by reference in their entirety. Inclinations more severe than that, which can be accommodated by the mid-joint connectors, can be accommodated by specialized connectors, also illustrated in Appendix A.

The fence post connector configured as described above has many advantages over the 440 Fence connector. For instance:
It is much easier to produce with the entire body, including the grommet receiving grooves, threads, and undercuts being castable in one step with no post casting machining being required.
Only one connector is required at each joint, as opposed to two with the 440 Fence connector.
Only one setscrew is required to couple two adjacent rail section ends to a fence post, as opposed to six being required for the 440 Fence connector. This reduces damage to the tubing and reduces labor.
The aluminum connector cannot rust.
The connector is much lighter than the 440 Fence connector.
The simplified construction results in labor savings of nearly 30% per installation.

Although the best mode contemplated by the inventors of carrying out the present invention is disclosed above, practice of the present invention is not limited thereto. It will be manifest that various additions, modifications, and rearrangements of the features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments.

I claim:

1. A fence post connector comprising:
a body having a vertical throughbore for accepting a post therein;
at least one horizontal socket extending into the body and movably housing an end of an elongate rail section, and
a resilient isolating member, mounted in the socket, for holding the rail section in place while accommodating limiting pivoting of the rail section relative to the connector in both the horizontal and vertical planes.

2. The fence post connector of claim 1, wherein, when the rail section end is inserted into the socket, a gap is defined between an inner peripheral surface of the socket and an outer surface of the rail section, and wherein the resilient isolating member spans the gap around at least a portion of the perimeter of the socket.

3. The fence post connector of claim 2, wherein the resilient isolating member comprises an elastomeric grommet.

4. The fence post connector of claim 1, wherein two sockets are formed on opposed sides of the body, and wherein a resilient isolating member is disposed in each socket.

5. The fence post connector of claim 4, wherein the sockets are formed from opposite end sections of a horizontal throughbore formed in the body.

6. The fence post connector of claim 1, wherein a threaded internal boss extends into the vertical throughbore and receives a setscrew assembly.

7. The fence assembly of claim 6, wherein the setscrew assembly includes a setscrew having a hardened steel insert.

8. The fence assembly of claim 6, wherein the setscrew assembly includes a setscrew having an end surface and a resilient member extending from the setscrew end surface for temporarily fixing the body to the post by deforming against and frictionally interfacing the post.

9. A fence assembly comprising comprising:
a vertical post;
an elongate rail section having an end; and
a connector including a body having a vertical throughbore that receives the post and a horizontal socket that receives the rail section end, the socket having an inner diameter that is significantly larger than a maximum diameter of the rail section end so as to define a gap therebetween that permits vertical and horizontal pivoting of the rail section relative to the connector.

10. The fence assembly of claim 9, wherein the connector further comprises an isolating member that spans the gap to center the end of the rail section in the socket while permitting pivoting of the rail section with respect to the body.

11. The fence assembly of claim 10, wherein the isolating member is made from an elastomeric material.

12. The fence assembly of claim 10, wherein the isolating member is generally annular, defining first and second side openings at opposing sides thereof, each of the first and second openings having a respective diameter, and the magnitude of the first diameter being greater than the magnitude of the second diameter.

13. The fence assembly of claim 10, wherein the isolating member is a grommet.

14. The fence assembly of claim 10, wherein the rail section includes a cap mounted thereto, the cap having a diameter sufficiently great in magnitude to mechanically interface with the isolating member when the rail section is urged axially outward from the socket.

15. The fence assembly of claim 9, wherein the body and the rail section are made of dissimilar materials.

16. The fence assembly of claim 15, wherein the isolating member at least one of 1) provides electrical isolation of the dissimilar materials and 2) mitigates galvanic-type corrosion adjacent the connector.

17. The fence assembly of claim 9, wherein the rail section end includes a projection extending radially therefrom and extending about a major portion of the periphery of the elongate rail.

18. A method of installing a fence comprising:
installing a post into a supporting substrate;
providing a fence post connector including body having a socket extending transversely thereinto;
mounting the connector to the upright post;
connecting an end of an elongate rail section to the connector so as to support the rail section end while allowing vertical and horizontal pivoting of the rail section relative to the connector.

19. The method of claim 18, wherein the connector includes a vertical throughbore and a horizontal socket, the mounting step includes inserting the post into the throughbore, and the connecting step comprises inserting the rail section end into the socket.

20. The method of claim 18, wherein the connecting step comprises engaging a resilient isolating member in the socket with an outer peripheral surface of the rail section end.
